(19) United States
(12) Patent Application Publication
(10) Pub. No.: US 2020/0265643 A1
(43) Pub. Date: Aug. 20, 2020

(54) Selective Presentation of Augmented Reality Objects

(71) Applicant: AT&T Intellectual Property I, L.P., Atlanta, GA (US)

(72) Inventors: Robert Koch, Norcross, GA (US); Ari Craine, Marietta, GA (US)

(73) Assignee: AT&T Intellectual Property I, L.P., Atlanta, GA (US)

(21) Appl. No.: 16/278,251

(22) Filed: Feb. 18, 2019

(51) Int. Cl. G06T 19/00; G09G 5/00; H04L 12/58; H04L 29/08; H04M 3/42

(52) U.S. Cl. CPC G06T 19/006; G09G 5/003; H04M 2203/205; H04L 67/02; H04M 3/42; H04L 51/04

(57) ABSTRACT

Concepts and technologies for selective presentation of augmented reality (“AR”) objects are described. An AR system can retrieve a live video image, receive a first message, present the first message on an AR display, and determine, from the live video image, a first anchor over which a first object that is representative of the first message is to be presented. The AR system can then present, over the first anchor, the first object. The AR system can receive a subsequent message, and can determine, from the live video image, a second anchor over which a second object that is representative of the subsequent message is to be presented. The AR system can receive a notification, and, in response, can determine to forgo presentation, over the second anchor, of the second object. Instead, the AR system can present, over the second anchor, a third object that is representative of the notification.

### BACKGROUND

Augmented reality (“AR”) is a technology that uses digital images to augment real images perceived by a user. AR technology has been incorporated into glasses, whereby the user's vision is augmented by the presentation of digital images on a lens of the glasses to appear as if the digital images overlay real-world objects. Other implementations of AR technology overlay digital images on an image captured by a camera. Modern smartphones have proven to be successful AR devices due, in part, to the high resolution displays and cameras in combination with advanced processing components. AR application development for smartphones has grown substantially in the past few years because of the software development tools that operating system providers have devoted to AR technology. Many AR applications focus on entertainment, such as gaming, but relevant use cases can be found in numerous industries.

Text-based messaging has become a ubiquitous form of communication, often usurping traditional voice calling as the preferred method of communication for many people in some situations. Unfortunately, a common situation in which people use text-based messaging instead of voice calling is while driving. In many states, the law regarding distracted driving has been updated to prohibit any in-hand use of a device, such as for making voice calls or engaging in text-based messaging. Hands-free technologies, such as speaker phone, BLUETOOTH connectivity, and digital assistants such as SIRI (available from Apple Inc.) allow people to communicate without the distraction of an in-hand device. Some people cannot resist the temptation to use their device while driving, regardless of the laws in their community. This puts themselves and other people at risk. Any technology that mitigates device use while driving can potentially save lives, and is worth investigating further.

### SUMMARY

Concepts and technologies disclosed herein are directed to aspects of selective presentation of augmented reality (“AR”) objects. According to one aspect disclosed herein, an AR system can include a communications component, a camera component, an AR display, a processor, and a memory. The memory can have instructions stored thereon that, when executed by the processor, cause the processor to perform operations. The AR system can retrieve a live video image from the camera component. The AR system can receive, via the communications component, such as from a network, a first message. The AR system can present the first message using AR technology, such as on the AR display. In particular, the AR system can determine, from the live video image, a first AR object anchor over which a first AR object that is representative of the first message is to be presented. In other words, the first AR object anchor can be a real-world object over which the first AR object can be presented. One non-limiting example described herein is the live video image being a video image of a roadway, which can include signs, one of which can be determined as the first AR object anchor. The first message, formatted as the first AR object, can be overlaid on the first AR object anchor to appear as if the first message is part of the sign. In some implementations, the first AR object is positioned over the first AR object anchor so as not to obscure a certain portion of the sign. For example, the sign might include directions or other useful information that should not be covered. The AR system can then present, via the AR display, over the first AR object anchor, the first AR object that is representative of the first message. The AR system can receive, via the communications component, a subsequent message for AR presentation. The subsequent message can be associated with and different from the first message. For example, the first message might be a first message in an interactive conversation between two people, and the subsequent message might be another message in the interactive conversation. Similarly, the interactive conversation might take place between a user of the AR system and a digital assistant, application, or other entity. The AR system can determine, from the live video image, a second AR object anchor over which a second AR object that is representative of the subsequent message is to be presented. The AR system also can receive, via the communications component, a notification, and, in response to the notification, the AR system can determine to forgo presentation, over the second AR object anchor, of the second AR object that is representative of the subsequent message. Instead, the AR system can present, via the AR display, over the second AR object anchor, a third AR object that is representative of the notification. After the third AR object that is representative of the notification has been presented, the AR system can determine, from the live video image, a third AR object anchor over which the second AR object that is representative of the subsequent message is to be presented, and can present, via the AR display, over the third AR object anchor, the second AR object that is representative of the subsequent message.

In some contemplated implementations, the live video image can include a roadway and a plurality of signs. In these implementations, each of the AR object anchors can be associated with at least one of the plurality of road signs. As mentioned in the example above, the first and subsequent message can be part of an interactive conversation. The interactive conversation can include a text-based messaging conversation in which the first message and subsequent message are text messages. In some embodiments, the notification is associated with a priority ranking that prioritizes the notification over the subsequent message. In some embodiments, the notification is associated with an application executed by a user device, an Internet of Things (“IoT”) device, a vehicle system notification, a travel notification, a roadwork notification, an AMBER alert notification, a government notification, or a weather notification.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts disclosed herein.

FIGS. 2A-2F are diagrams illustrating example roadway views, each including a live video image and an augmented reality overlay, according to illustrative embodiments of the concepts and technologies disclosed herein.

FIG. 3 is a flow diagram illustrating aspects of a method for selective presentation of augmented reality objects, according to an illustrative embodiment.

FIG. 4 is a block diagram illustrating an example mobile device, according to some illustrative embodiments.

FIG. 5 is a block diagram illustrating an example computer system, according to some illustrative embodiments.

FIG. 6 schematically illustrates a network, according to an illustrative embodiment.

### DETAILED DESCRIPTION

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

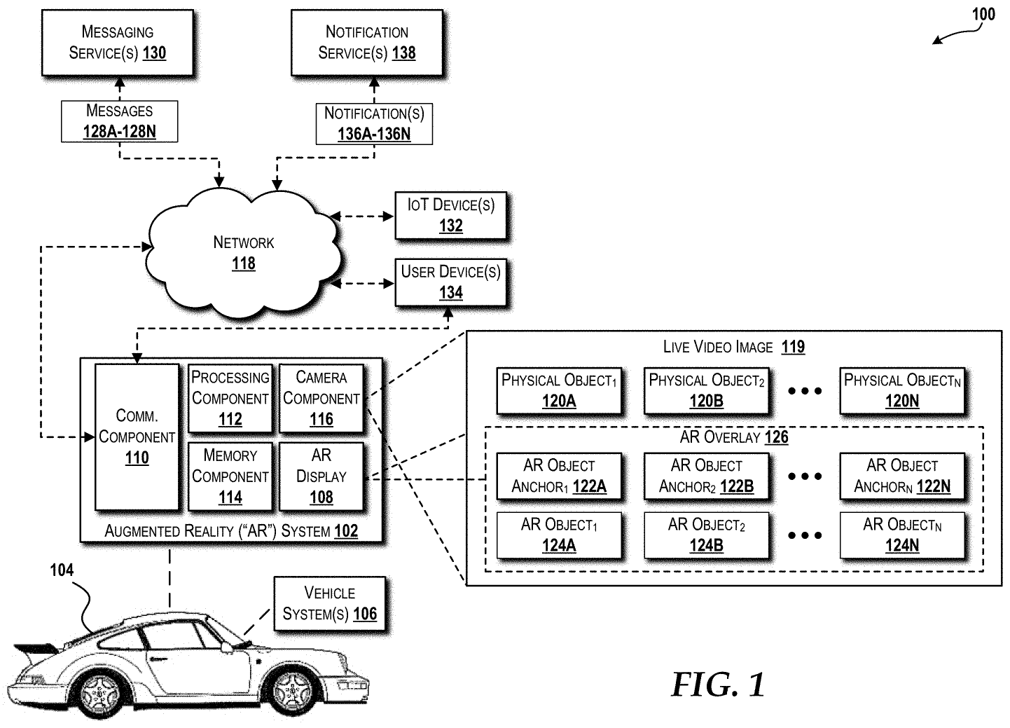

Turning now to FIG. 1, an operating environment 100 in which embodiments of the concepts and technologies disclosed herein will be described. The illustrated operating environment 100 includes an augmented reality (“AR”) system 102. The illustrated AR system 102 is shown for use in a vehicle 104. Those skilled in the art will appreciate the applicability of the concepts and technologies disclosed herein to other use cases, and as such, the AR system 102 for use in the vehicle 104 should not be construed as being limiting in any way.

The AR system 102 can be a standalone or dedicated system. Both original equipment and aftermarket versions of the AR system 102 are contemplated. For example, the vehicle 104 might be optioned with factory or dealer-installed original equipment that provides the capabilities of the AR system 102 described herein. Aftermarket implementations of the AR system 102 can be added to the vehicle 104 to provide the capabilities of the AR system 102 described herein. In some embodiments, the AR system 102 is one of one or more vehicle systems 106, or a sub-system thereof. For example, components of the AR system 102 might be integrated with other vehicle systems 106. As one non-limiting example, a head-up display or navigation (and/or infotainment) display might provide at least part of the functionality of an AR display 108 the AR system 102. The vehicle systems 106 can include systems associated with any aspect of the vehicle 104. For example, the vehicle systems 106 can include the engine, fuel system, ignition system, electrical system, exhaust system, drivetrain system, suspension system, steering system, braking system, parking assistance system (e.g., parking sensors), navigation system, radio system, infotainment system, communication system (e.g., in-car WI-FI and/or cellular connectivity), BLUETOOTH and/or other connectivity systems that allow connectivity with other systems, devices, and/or networks, driver assistance system (e.g., lane departure warning, lane keep assist, blind spot monitoring, parking assist, cruise control, automated cruise control, autonomous mode, semi-autonomous mode, and the like), tire pressure monitoring systems, other sensor systems, combinations thereof, and the like. In some embodiments, the AR system 102 shares components and/or capabilities with the vehicle system(s) 106, such as the AR display 108 in the example mentioned above.

The illustrated AR system 102 includes, in addition to the AR display 108, a communications component 110, a processing component 112, a memory component 114, and a camera component 116. The communications component 110 can facilitate communications between the AR system 102 and a network 118. In some embodiments, the network 118 can include one or more wireless local area networks (“WLANs”), one or more wireless wide area networks (“WWANS”), one or more wireless metropolitan area networks (“WMANs”), one or more campus area networks (“CANs”), and/or one or more packet data networks (e.g., the Internet). The AR system 102 can communicate with the network 118, via the communications component 110, using any wireless communications technology or combination of wireless communications technologies, some examples of which include, but are not limited to, WI-FI, Global System for Mobile communications (“GSM”), Code Division Multiple Access (“CDMA”) ONE, CDMA2000, Universal Mobile Telecommunications System (“UMTS”), Long-Term Evolution (“LTE”), Worldwide Interoperability for Microwave Access (“WiMAX”), other Institute of Electrical and Electronics Engineers (“IEEE”) 802.XX technologies, and the like. The AR system 102 can communicate with the network 118 via various channel access methods (which may or may not be used by the aforementioned technologies), including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Single-Carrier FDMA (“SC-FDMA”), Space Division Multiple Access (“SDMA”), and the like. Data can be exchanged between the AR system 102 and the network 118 via cellular data technologies such as, but not limited to, General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. It should be understood that the network 118 may additionally include infrastructure that operates on wired communications technologies, including, but not limited to, optical fiber, coaxial cable, twisted pair cable, and the like to transfer data between various systems operating on or in communication with the network 118, such as the AR system 102 and the vehicle system(s) 106. In some embodiments, the communications component 110 enables short-range communications between the AR system 102 and one or more of the vehicle system 106, which might, in turn, communicate via a wireless communications technology, such as described above, with the network 118. Those skilled in the art will appreciate the numerous configurations that the AR system 102 and/or the vehicle system(s) 106 might take to facilitate communications with an external network, such as the network 118. As such, the example embodiments described herein should not be construed as being limiting in any way.

The processing component 112 can include a central processing unit (“CPU”) configured to process data, execute computer-executable instructions of one or more application programs, and communicate with other components of the AR system 102 in order to perform various functionality described herein. The processing component 112 can execute instructions of the software components presented herein.

In some embodiments, the processing component 112 includes a graphics processing unit (“GPU”) configured to accelerate operations performed by the CPU, including, but not limited to, operations performed by executing AR applications such as those described herein, general-purpose scientific and engineering computing applications, as well as graphics-intensive computing applications such as high resolution video (e.g., 480i/p, 720i/p, 1080i/p, 4K, 8K, and greater resolutions), video games, three-dimensional modeling applications, and the like. In some embodiments, the processing component 112 can communicate with a discrete GPU (not shown). In any case, the CPU and GPU can be configured in accordance with a co-processing CPU/GPU computing model, wherein the sequential part of an application executes on the CPU and the computationally-intensive part, such as the generation and presentation of AR objects, is accelerated by the GPU.

In some embodiments, the processing component 112 is, or is included in, a system-on-chip (“SoC”) along with one or more of the other components described herein below. For example, the SoC can include the processing component 112, the memory component 114, and the communications component 110. In some embodiments, the processing component 112 is fabricated, in part, utilizing a package-on-package (“PoP”) integrated circuit packaging technique. Moreover, the processing component 112 can be a single core or multi-core processor.

The processing component 112 can be created in accordance with an ARM architecture, available for license from ARM HOLDINGS of Cambridge, United Kingdom. Alternatively, the processing component 112 can be created in accordance with an x86 architecture, such as is available from INTEL CORPORATION of Mountain View, Calif. and others. In some embodiments, the processing component 112 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory component 114 can include random access memory (“RAM”), read-only memory (“ROM”), integrated storage memory, removable storage memory, or any combination thereof. In some embodiments, at least a portion of the memory component 114 is integrated with the processing component 112. In some embodiments, the memory component 114 is configured to store a firmware, an operating system or a portion thereof (e.g., operating system kernel), one or more application (e.g., AR applications), and/or a bootloader to load an operating system kernel.

Integrated storage memory can include a solid-state memory, a hard disk, or a combination of solid-state memory and a hard disk. The integrated storage memory can be soldered or otherwise connected to a logic board upon which the processing component 112 and other components described herein also may be connected. The integrated storage memory can store an operating system or portions thereof, application programs, data, and other software components described herein.

Removable storage memory can include a solid-state memory, a hard disk, or a combination of solid-state memory and a hard disk. In some embodiments, the removable storage memory is provided in lieu of the integrated storage memory. In other embodiments, the removable storage memory is provided as additional optional storage. In some embodiments, the removable storage memory is logically combined with the integrated storage memory such that the total available storage is made available and shown to a user as a total combined capacity.

The removable storage memory can be inserted into a removable storage memory slot (not shown) or other mechanism by which the removable storage memory is inserted and secured to facilitate a connection over which the removable storage memory can communicate with other components of the AR system, such as the processing component 112. The removable storage memory can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like. As a UICC, the memory component 114 can be part of the communications component 110.

It should be understood that the memory component 110 can store an operating system. According to various embodiments, the operating system includes, but is not limited to, LINUX, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The camera component 116 can be configured to capture still images and/or video. The camera component 116 might utilize a charge coupled device (“CCD”) or a complementary metal oxide semiconductor (“CMOS”) image sensor to capture images, although other image capturing technologies are contemplated. In some embodiments, the camera component 116 includes a flash and/or other accessory components to enhance the capabilities of the image sensor.

The camera component 116 is described herein as capturing a live video image 119, such as in the illustrated example. One or more physical objects 120A-120N (also referred to herein as physical objects 120) can be present in the live video image 119. The physical objects 120 can be or can include any physical objects. In one implementation where the live video image 119 is taken from the front of the vehicle 104 so as to capture what the driver sees as he or she drives the vehicle 104, the physical objects 120 might include a roadway and a plurality of signs along the sides of the roadway, over the roadway, or elsewhere within the live video image 119. The AR system 102 can determine which of the physical object(s) 120 can be used as an AR object anchor, such as one of the AR object anchors 122A-122N (also referred to herein as AR object anchors 122), to which an AR object, such as one of the AR objects 124A-124N (also referred to herein as AR objects 124), can be associated as part of an AR overlay 126 generated by the AR system 102 and presented via the AR display 108 over the live video image 119. This determination can be made based upon content type, size, shape, color, or any other physical characteristic of the physical object 120.

The AR display 108 can present the live video image 119 and the AR overlay 126. The AR display 108 can use part of an existing display component of the vehicle 104, such as a head-up display or navigation (and/or infotainment) display provided in the vehicle system(s) 106. Alternatively, the AR display 108 can be dedicated to the AR system 102, and can be embodied in various forms. In some embodiments, the AR display 108 is a digital display with or without touchscreen capabilities. In some other embodiments, the AR display 108 is integrated into at least a portion of a windshield of the vehicle 104. In some other embodiments, the AR display 108 is a head-up display that is projected onto the windshield or another display canvas, such as piece of clear glass or clear plastic. The display technology used, resolution, dimensions, and other specifications of the AR display 108 can be selected based upon the particular application. As such, the embodiments disclosed herein and described with reference to any particular display technology, resolution, dimension, and/or other specification should not be construed as being limiting in any way.

The AR system 102 can receive one or more messages 128A-128N from one or more message services 130. The message services 130 can include any text-based messaging service, some examples of which include, but are not limited to, short message service (“SMS”), Internet protocol (“IP”)-based messaging (e.g., in-app messaging or native messaging), and email. The messaging services 130 can send messages to and receive messages from the network 118, which can encompasses one or more networks designed, at least in part, to support the messaging services 130. As such, the network 130 can be or can include one or more cellular networks that support SMS and/or one or more IP-based network that support IP-based messaging and/or email.

The AR system 102 can receive, via the communications component 110, the messages 128 for AR presentation on the AR display 108. The messages 128, in some embodiments, can be associated with an interactive conversation, such as a text-based messaging service conversation between two entities, which might include people, bots, digital assistants, and/or devices, including one or more Internet of Things (“IoT”) devices 132 and/or one or more user devices 132. The AR system 102 can determine, from the live video image 119, a first AR object anchor (e.g., the AR object anchor₁ 122A) over which a first AR object (e.g., the AR object₁ 124A) that is representative of a first message of the messages 128 (e.g., a first message₁ 128A) is to be presented. The AR system 102 can present, via the AR display 108, over the first AR object anchor 122A, the first AR object 124A that is representative of the first message 128A. The AR system 102 can then receive a subsequent message (e.g., a second message₂ 128B), which as noted above, might be part of an interactive conversation in that it is associated with and different from the first message 128A. It should be understood, however, that the subsequent message does not have to be associated, in any way, with the first message 128A. Moreover, the subsequent message might repeat the content of the first message 128A. The AR system 102 can determine, from the live video image 119, a second AR object anchor (e.g., the AR object anchor₂ 122B) over which a second AR object (e.g., the AR object₂ 124A) that is representative of the subsequent message of the messages 128 (e.g., the second message₂ 128B) is to be presented.

The AR system 102 also can receive, via the communications component 110, one or more notifications 136A-136N from one or more notification services 138. The notification services 138 can include any notification service, some examples of which include, but are not limited to, application notifications, vehicle notifications, travel notifications, roadwork notifications, prioritized notifications, AMBER alert notifications, other government notifications, weather notifications, and/or the like. The notification services 138 can send notifications to and receive messages from the network 118, which can encompasses one or more networks designed, at least in part, to support the notification services 138. The notification services 138 can include notifications 136 from one or more applications running on or otherwise associated with the IoT devices 132 and/or the user devices 134. The notification services 138 also can include notifications from the vehicle system(s) 106, such as a notification that a portion of one or more of the vehicle systems 106 has failed or otherwise needs attention.

The notifications 136 are different from the messages 128. The notifications 136 are used to inform the driver of the vehicle 104 of some information. This information might even include notifying the driver of one or more of the messages 128, but not the messages 128 themselves. The notifications 136 can be external from the IoT device(s) 132 and/or the user devices 134, but also can be internal from the AR system 102 itself or local to the vehicle 104, such as by one or more of the vehicle systems 106 or the driver's device or passenger's device, such as one of the user devices 134 embodied, for example, as a smartphone that can send and receive messages 128, from one or more messaging applications executed by the user device 134, and can receive notifications 136, from one or more applications, including messaging applications, AR applications, navigation applications, music applications, audiobook applications, and/or any other application executed by the user device 134 (e.g., the driver or passenger's user device). While the embodiments presented herein include primarily a text element for the messages 128 and the notifications 136, the messages 128 and/or the notifications 136 might additionally or alternatively include other types of elements for visual display, such as, for example, an image element (e.g., a photo from a doorbell camera acting as one of the IoT devices 132), or a video element (e.g., a brief video recorded by the sender of the message 128).

The AR system 102 can receive, via the communications component 110, one of the notifications 136 (e.g., a first notification 136A). In response to receiving the first notification 136A, the AR system 102 can determine to forgo presentation, over the second AR object anchor 122B, of the second AR object 124B that is representative of the subsequent message (e.g., the second message 128B). The AR system 102 can instead present, via the AR display 108, over the second AR object anchor 122B, a third AR object (e.g., an AR object₃ 124C) that is representative of the first notification 136A. In some embodiments, the AR system 102 can determine to forgo presentation based upon a priority ranking of the first notification 136A over the second message 128B. The priority ranking can be established based upon the type of notification. The priority ranking can be established based upon the content of the first notification 136A and the second message 128B. The priority ranking can be established by any entity via the AR system 102, the vehicle system(s) 106, the IoT device(s) 132, the user device(s) 134, or other systems/devices not shown. The entity can be or can include a user (e.g., a driver or passenger of the vehicle 104), a government entity (e.g., in the case of the first notification including an AMBER alert), a service provider (e.g., a service provider that provides, at least in part, one or more of the messaging services 130, the notification service(s) 138, and/or communication services (e.g., wireless telecommunication services) via the network 118, an application or operating system executed by the AR system 102, the vehicle system(s) 106, the IoT device(s) 132, and/or the user device(s) 134. Priority ranking might also be based upon the sender's hierarchical priority as opposed to other senders. For example, for a given user, a given sender of the message 128 might have a higher priority ranking than other senders. In another example, notifications from certain IoT devices may have a higher priority ranking than some (but not necessarily all) senders' text messages. This is not to limit, however, the number of potential concurrent conversations that can be in progress. For instance, a user might receive a sequence of text messages within a conversation that are interspersed with other types of notifications.

Each of the user devices 134, in some embodiments, can be or can include a mobile device such as, for example, smartphone, tablet device, personal digital assistants, laptop computer, or the like. The user device 134, in some other embodiments, is a wearable device such as, for example, smart watch, smart eyeglass/sunglass, smart jewelry, fitness accessory, or the like. In some other embodiments, the user device 134 is an implanted device that is implanted within a user, such as the driver or a passenger of the vehicle 104. The user device 134, in some embodiments, is in communication with the AR system 102 and/or the vehicle system(s) 106. Communication between the user devices 134 and the AR system 102 can be facilitated by a short-range communications technologies such as, for example, BLUETOOTH, BLUETOOTH low energy (“BLE”), infrared, infrared data association (“IRDA”), near field communications (“NFC”), other RF technologies, or the like. Communication between the user devices 134 and the AR system 102 can be facilitated by WI-FI, other wireless technologies, or wired technologies. Communication between the user devices 134 and the AR system 102 can be facilitated via the network 118.

Each of the IoT devices 132 can be a device that is network addressable to facilitate interconnectivity for the exchange of data, such as via the network 118 to the AR system 102 in form of one or more of the notifications 136. As such, the IoT devices 132 can be or can include any “thing” that is configured to be network addressable so as to connect to and communicate with one or more networks, such as the network 118, over which to communicate with other connected devices, including, for example, the user devices 134, the AR system 102, the vehicle system(s) 106, computers, smartphones, tablets, the vehicle 104, other vehicles, other machine-to-machine devices, servers, other networks, the Internet, combinations thereof, and the like. Moreover, the IoT devices 132 can be deployed for consumer use, business use, and can find application in many industry specific use cases. For example, the IoT devices 132 may find at least partial application in the following industries: automotive; energy; healthcare; industrial; retail; and smart buildings/homes (e.g., security, light control, door lock control, and/or other automations). Those skilled in the art will appreciate the applicability of IoT solutions to other industries as well as consumer and business use cases. For this reason, applications of the IoT devices 132 described herein are used merely to illustrate some example applications of the IoT devices 132, and therefore should not be construed as being limiting in any way.

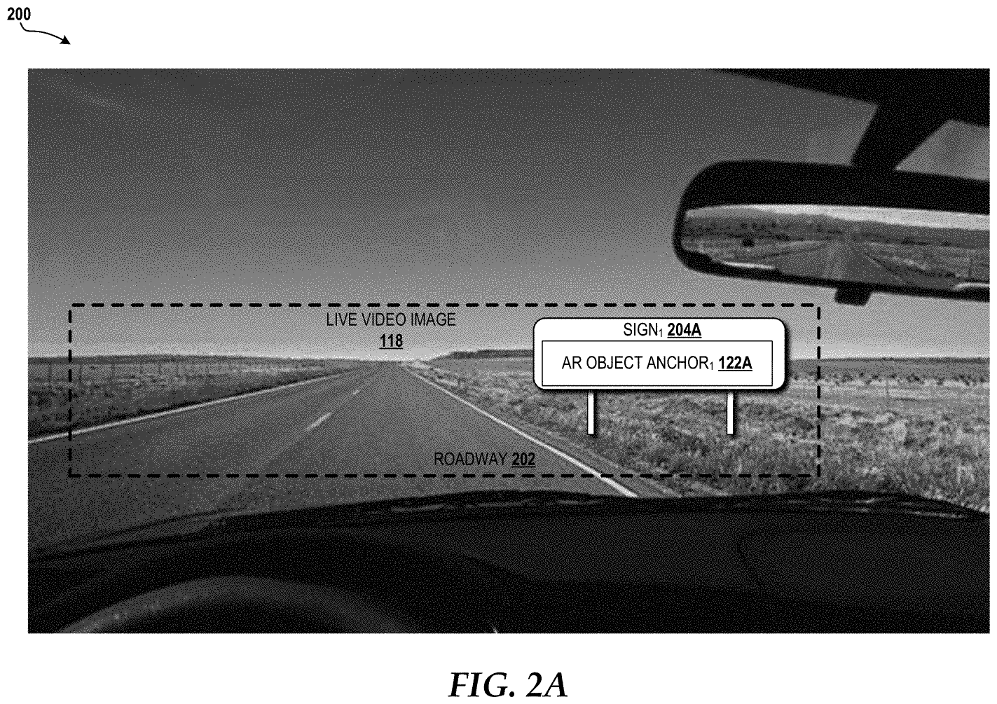

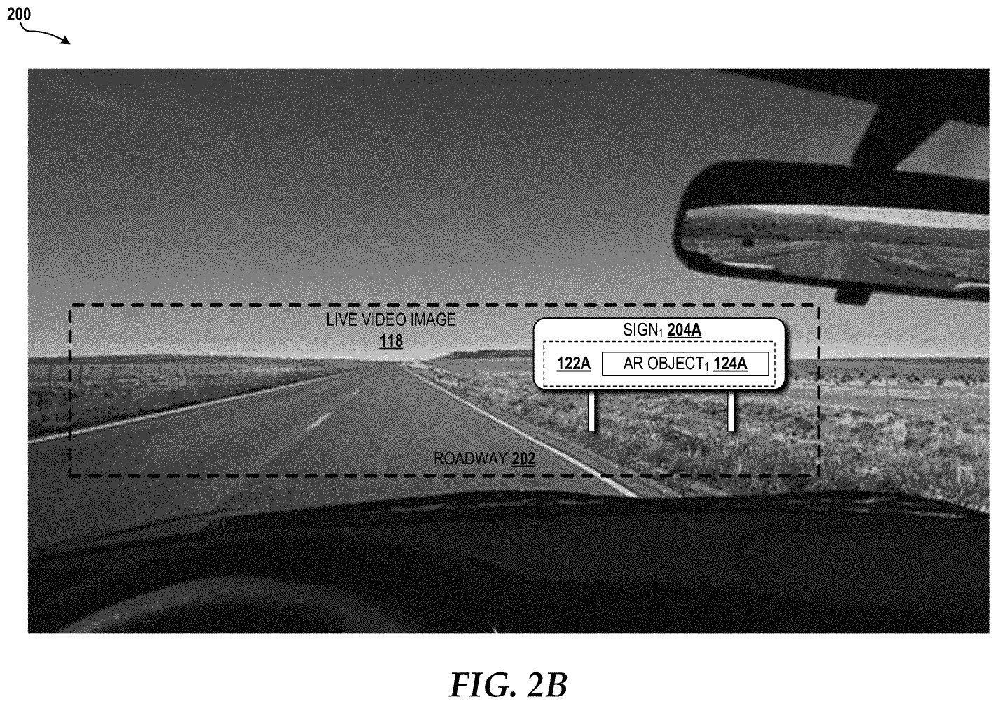

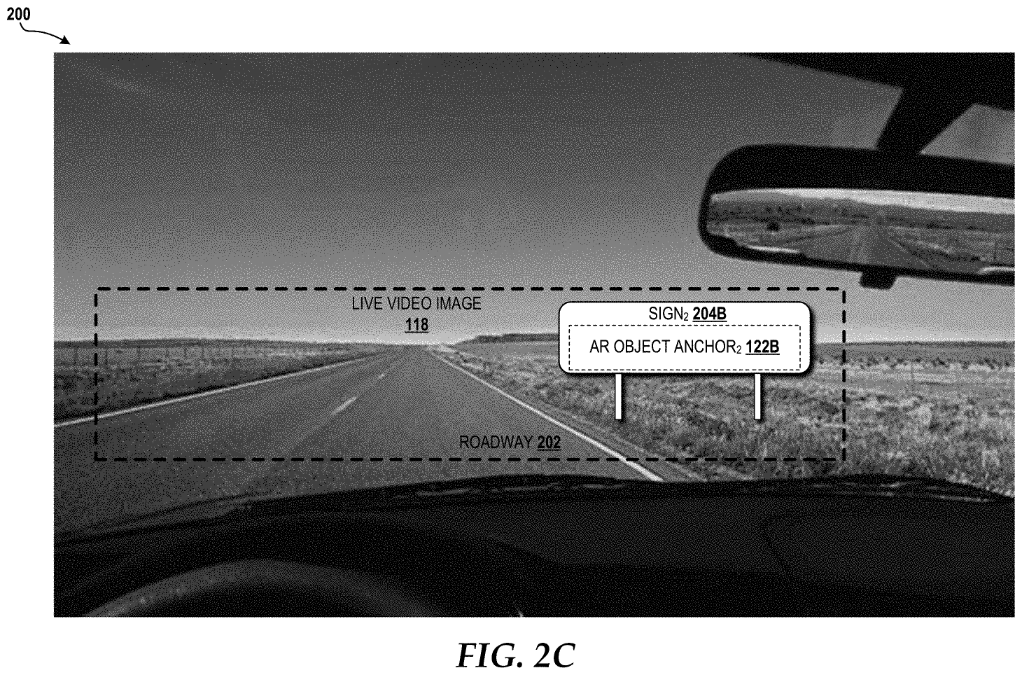

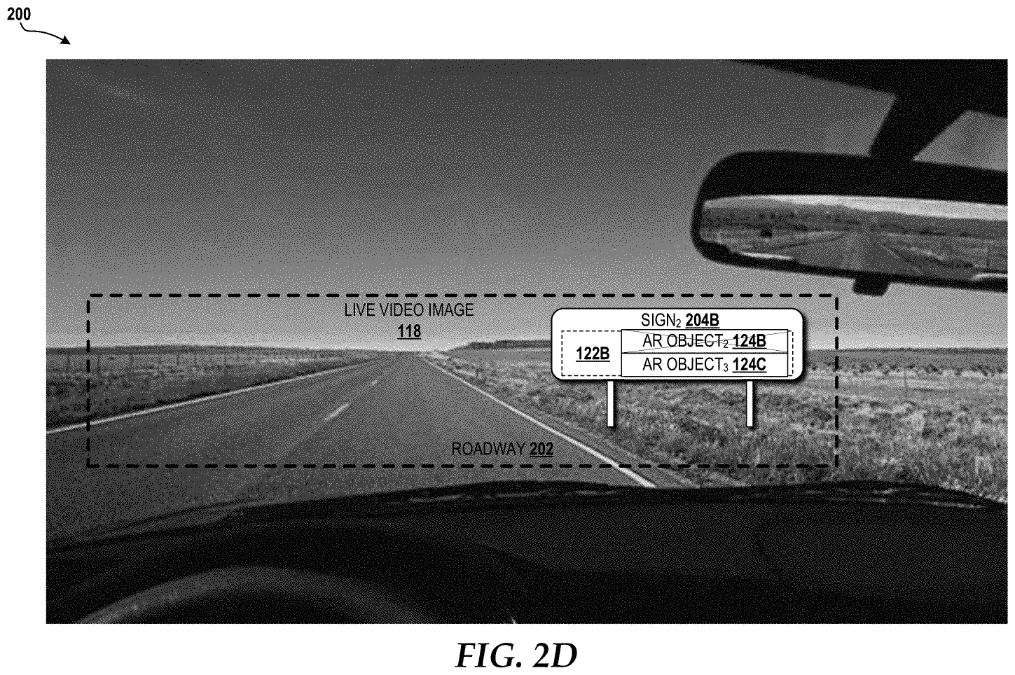

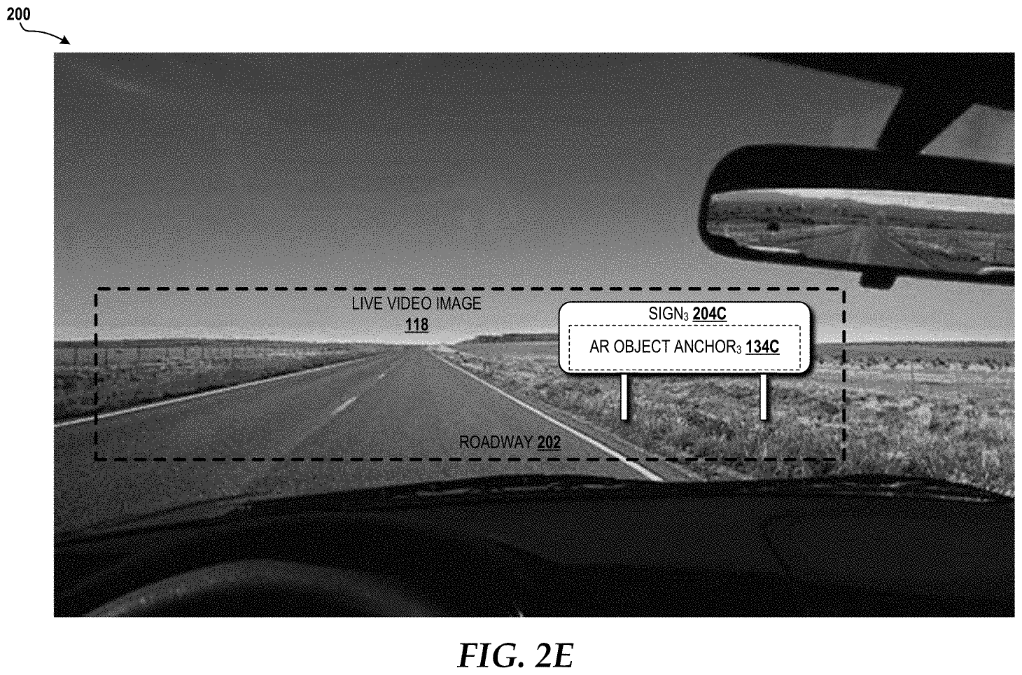

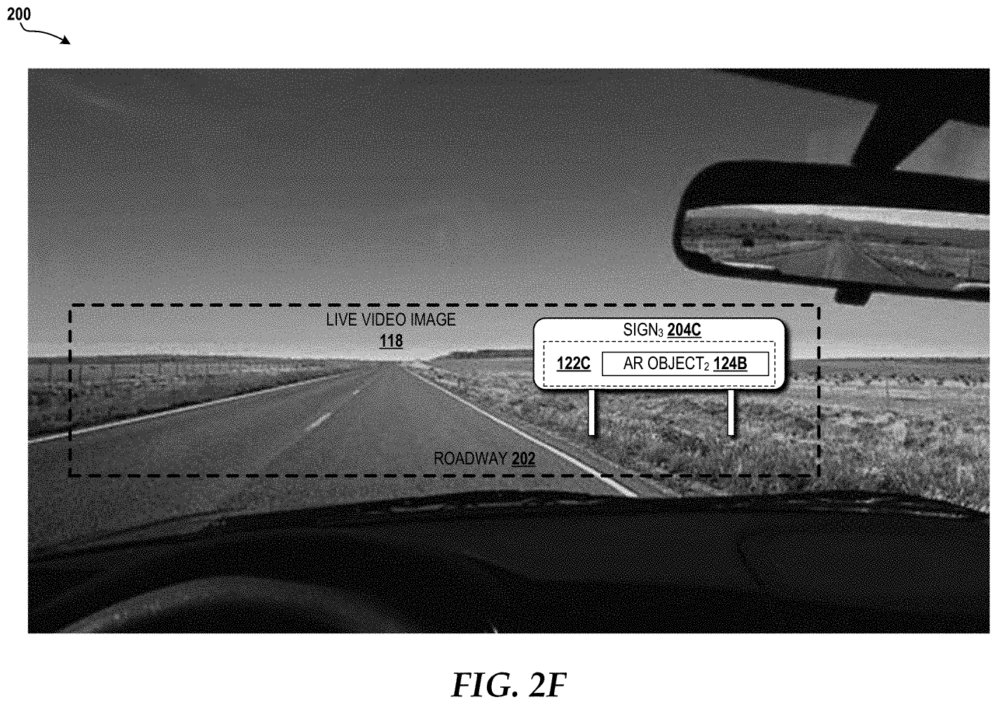

Turning now to FIGS. 2A-2F, diagrams illustrating example roadway views 200, each including a live video image (e.g., the live video image 119) and an AR overlay (e.g., the AR overlay 126) will be described, according to illustrative embodiments of the concepts and technologies disclosed herein. FIGS. 2A-2F will be described with additional reference to FIG. 1.

Referring first to FIG. 2A, the roadway view 200 shows, in the live video image 119, a roadway 202 as one of the physical objects 120, and a first sign 204A as another one of the physical objects 120. The first sign 204A, in the illustrated example, is determined, by the AR system 102, to be the first AR object anchor 122A.

Referring now to FIG. 2B, the roadway view 200 again shows, in the live video image 119, the roadway 202 and the first sign 204A, with the first sign 204A being determined, by the AR system 102, to be the first AR object anchor 122A. The AR system 102 also determines that the first AR object 124A that is representative of one of one the messages 128 is to be presented over the first AR object anchor 122A.

Referring now to FIG. 2C, the roadway view 200 shows, in the live video image 119, the roadway 202 as one of the physical objects 120, and a second sign 204B as another one of the physical objects 120. The second sign 204B, in the illustrated example, is determined, by the AR system 102, to be the second AR object anchor 122B.

Referring now to FIG. 2D, the roadway view 200 again shows, in the live video image 119, the roadway 202 and the second sign 204B, with the second sign 204B being determined, by the AR system 102, to be the second AR object anchor 124B. The AR system 102 also determines to forgo presentation of the second AR object 124B (illustrated as the AR object₂ 124B crossed through) that is representative of one the messages 128 (e.g., a subsequent message) over the second AR object anchor 122B. The AR system 102 can instead present, over the second AR object anchor 122B, a third AR object (e.g., the AR object₃ 124C) that is representative of one of the notifications 136.

Referring now to FIG. 2E, the roadway view 200 shows, in the live video image 119, the roadway 202 as one of the physical objects 120, and a third sign 204C as another one of the physical objects 120. The third sign 204C, in the illustrated example, is determined, by the AR system 102, to be the third AR object anchor 122C.

Referring now to FIG. 2F, the roadway view 200 again shows, in the live video image 119, the roadway 202 and the third sign 204C, with the third sign 204C being determined, by the AR system 102, to be the third AR object anchor 122C. The AR system 102 also determines that the second AR object 124B that is representative of another one of one the messages 128 (e.g., the subsequent message) is to be presented over the third AR object anchor 122C.

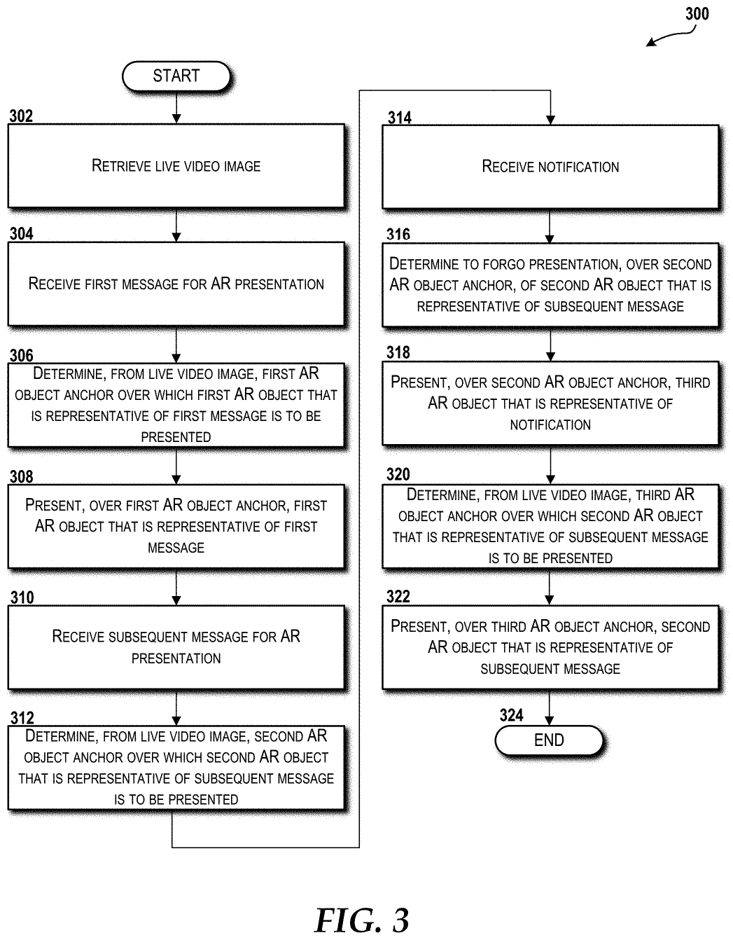

Turning now to FIG. 3, a flow diagram illustrating aspects of a method 300 for selective presentation of AR objects, such as the AR objects 124, will be described according to an illustrative embodiment. FIG. 3 will be described with additional reference to FIGS. 1 and 2A-2F. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, for example, the processing component 112 of the AR system 102, to perform one or more operations, and/or causing the processor to direct other components of the computing system or device to perform one or more of the operations.

For purposes of illustrating and describing the concepts of the present disclosure, operations of the methods disclosed herein are described as being performed by alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 will be described as being performed by the AR system 102. The method 300 begins and proceeds to operation 302, where the AR system 102 retrieves the live video image 119 via the camera component 116. From operation 302, the method 300 proceeds to operation 304, where the AR system 102 receives the first message 128A for AR presentation. From operation 304, the method 300 proceeds to operation 306, where the AR system 102 determines, from the live video image 119, the first AR object anchor 122A over which the first AR object 124A that is representative of the first message 128A is to be presented. From operation 306, the method 300 proceeds to operation 308, where the AR system 102 presents, over the first AR object anchor 122A, the first AR object 124 that is representative of the first message 128A.

From operation 308, the method 300 proceeds to operation 310, where the AR system 102 receives a subsequent message (e.g., the second message 128B) for AR presentation. From operation 310, the method 300 proceeds to operation 312, where the AR system 102 determines, from the live video image 119, the second object anchor 122B over which the second AR object 124B that is representative of the subsequent message is to be presented.

From operation 312, the method 300 proceeds to operation 314, where the AR system 102 receives a notification (e.g., the first notification 136A) from one of the notification services 138. From operation 314, the method 300 proceeds to operation 316, where the AR system 102 determines to forgo presentation, over the second AR object anchor 122B, of the second AR object 124B that is representative of the subsequent message. From operation 316, the method 300 proceeds to operation 318, where the AR system 102 presents, over the second AR object anchor 122B, the third AR object 124C that is representative of the first notification 136A.

From operation 318, the method 300 proceeds to operation 320, where the AR system 102 determines, from the live video image 119, the third object anchor 122C over which the second AR object 124B that is representative of the second message 128B is to be presented. From operation 320, the method 300 proceeds to operation 322, where the AR system 102 presents, over the third AR object anchor 122C, the second AR object 124B that is representative of the second message 128B. From operation 214, the method 200 proceeds to operation 216. The method 200 ends at operation 216.

The method 300 is described using an example of scenario in which the AR system 102 receives two messages 128A, 128B and one notification 136A. It should be understood, however, that the method 300 can be repeated any number of times to accommodate any number of messages 128 and notifications 136 received by the AR system 102. Moreover, receipt of the notification 136 might occur at a different time. For example, the AR system 102 might receive the notification 136 after three or more of the messages 128 are received or at any time between.

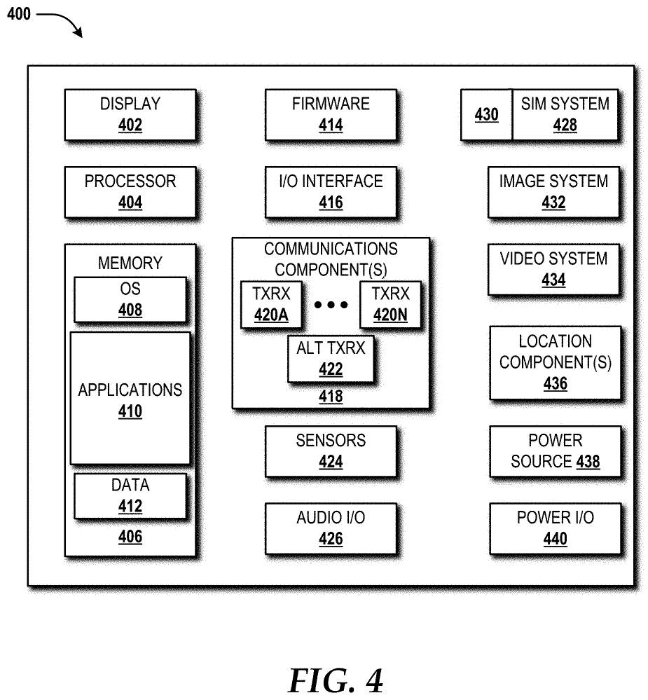

Turning now to FIG. 4, an illustrative mobile device 400 and components thereof will be described. In some embodiments, the user devices 134 described above with reference to FIG. 1 can be configured as and/or can have an architecture similar or identical to the mobile device 400 described herein with respect to FIG. 4. It should be understood, however, that the user devices 134 may or may not include the functionality described herein with reference to FIG. 4. While connections are not shown between the various components illustrated in FIG. 4, it should be understood that some, none, or all of the components illustrated in FIG. 4 can be configured to interact with one other to carry out various device functions. In some embodiments, the components are arranged so as to communicate via one or more busses (not shown). Thus, it should be understood that FIG. 4 and the following description are intended to provide a general understanding of a suitable environment in which various aspects of embodiments can be implemented, and should not be construed as being limiting in any way.

As illustrated in FIG. 4, the mobile device 400 can include a display 402 for displaying data. According to various embodiments, the display 402 can be configured to display any information. The mobile device 400 also can include a processor 404 and a memory or other data storage device (“memory”) 406. The processor 404 can be configured to process data and/or can execute computer-executable instructions stored in the memory 406. The computer-executable instructions executed by the processor 404 can include, for example, an operating system 408, one or more applications 410, other computer-executable instructions stored in the memory 406, or the like. In some embodiments, the applications 410 also can include a UI application (not illustrated in FIG. 4).

The UI application can interface with the operating system 408 to facilitate user interaction with functionality and/or data stored at the mobile device 400 and/or stored elsewhere, such as by the memory component 114 of the AR system 102. In some embodiments, the operating system 408 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 404 to aid a user (e.g., a driver or passenger of the vehicle 104) in interacting with at least a portion of the data associated with the AR system 102, the vehicle system(s) 106, other user devices 134, the IoT devices 132, the network 118, the messaging services 130, the notification services 138, and/or any other device(s), system(s), and/or service(s) not specifically described herein. The UI application can be executed by the processor 404 to aid a user in answering/initiating calls, entering/deleting other data, entering and setting user IDs and passwords for device access, configuring settings, manipulating address book content and/or settings, multimode interaction, interacting with other applications 410, and otherwise facilitating user interaction with the operating system 408, the applications 410, and/or other types or instances of data 412 that can be stored at the mobile device 400.

According to various embodiments, the applications 410 can include, for example, a web browser application, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 410, the data 412, and/or portions thereof can be stored in the memory 406 and/or in a firmware 414, and can be executed by the processor 404. The firmware 414 also can store code for execution during device power up and power down operations. It should be appreciated that the firmware 414 can be stored in a volatile or non-volatile data storage device including, but not limited to, the memory 406 and/or a portion thereof.

The mobile device 400 also can include an input/output (“I/O”) interface 416. The I/O interface 416 can be configured to support the input/output of data. In some embodiments, the I/O interface 416 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 400 can be configured to synchronize with another device to transfer content to and/or from the mobile device 400. In some embodiments, the mobile device 400 can be configured to receive updates to one or more of the applications 410 via the I/O interface 416, though this is not necessarily the case. In some embodiments, the I/O interface 416 accepts I/O devices such as other user devices 134, the IoT device(S), the vehicle system(s) 106, the AR system 102, keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 416 may be used for communications between the mobile device 400 and a network device or local device.

The mobile device 400 also can include a communications component 418. The communications component 418 can be configured to interface with the processor 404 to facilitate wired and/or wireless communications with one or more networks, such as the network 118. In some embodiments, the communications component 418 includes a multimode communications subsystem for facilitating communications via the cellular network and one or more other networks.

The communications component 418, in some embodiments, includes one or more transceivers. The one or more transceivers, if included, can be configured to communicate over the same and/or different wireless technology standards with respect to one another. For example, in some embodiments one or more of the transceivers of the communications component 418 may be configured to communicate using GSM, CDMAONE, CDMA2000, LTE, and various other 2G, 2.5G, 3G, 4G, 5G and greater generation technology standards. Moreover, the communications component 418 may facilitate communications over various channel access methods (which may or may not be used by the aforementioned standards) including, but not limited to, TDMA, FDMA, W-CDMA, OFDM, SDMA, and the like.

In addition, the communications component 418 may facilitate data communications using GPRS, EDGE, the HSPA protocol family including HSDPA, EUL or otherwise termed HSDPA, HSPA+, and various other current and future wireless data access standards. In the illustrated embodiment, the communications component 418 can include a first transceiver (“TxRx”) 420A that can operate in a first communications mode (e.g., GSM). The communications component 418 also can include an N^{th} transceiver (“TxRx”) 420N that can operate in a second communications mode relative to the first transceiver 420A (e.g., UMTS). While two transceivers 420A-N (hereinafter collectively and/or generically referred to as “transceivers 420”) are shown in FIG. 4, it should be appreciated that less than two, two, or more than two transceivers 420 can be included in the communications component 418.

The communications component 418 also can include an alternative transceiver (“Alt TxRx”) 422 for supporting other types and/or standards of communications. According to various contemplated embodiments, the alternative transceiver 422 can communicate using various communications technologies such as, for example, WI-FI, WIMAX, BLUETOOTH, BLE, infrared, infrared data association (“IRDA”), near field communications (“NFC”), other RF technologies, combinations thereof, and the like. As such, the alternative transceiver 422 can communications with the AR system 102 and/or the vehicle system(s) 106, for example.

In some embodiments, the communications component 418 also can facilitate reception from terrestrial radio networks, digital satellite radio networks, internet-based radio service networks, combinations thereof, and the like. The communications component 418 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 400 also can include one or more sensors 424. The sensors 424 can include temperature sensors, light sensors, air quality sensors, movement sensors, orientation sensors, noise sensors, proximity sensors, or the like. As such, it should be understood that the sensors 424 can include, but are not limited to, accelerometers, magnetometers, gyroscopes, infrared sensors, noise sensors, microphones, combinations thereof, or the like. One or more of the sensors 424 can be used to detect movement of the mobile device 400. Additionally, audio capabilities for the mobile device 400 may be provided by an audio I/O component 426. The audio I/O component 426 of the mobile device 400 can include one or more speakers for the output of audio signals, one or more microphones for the collection and/or input of audio signals, and/or other audio input and/or output devices.

The illustrated mobile device 400 also can include a subscriber identity module (“SIM”) system 428. The SIM system 428 can include a universal SIM (“USIM”), a universal integrated circuit card (“UICC”) and/or other identity devices. The SIM system 428 can include and/or can be connected to or inserted into an interface such as a slot interface 430. In some embodiments, the slot interface 430 can be configured to accept insertion of other identity cards or modules for accessing various types of networks. Additionally, or alternatively, the slot interface 430 can be configured to accept multiple subscriber identity cards. Because other devices and/or modules for identifying users and/or the mobile device 400 are contemplated, it should be understood that these embodiments are illustrative, and should not be construed as being limiting in any way.

The mobile device 400 also can include an image capture and processing system 432 (“image system”). The image system 432 can be configured to capture or otherwise obtain photos, videos, and/or other visual information. As such, the image system 432 can include cameras, lenses, charge-coupled devices (“CCDs”), combinations thereof, or the like. The mobile device 400 may also include a video system 434. The video system 434 can be configured to capture, process, record, modify, and/or store video content. Photos and videos obtained using the image system 432 and the video system 434, respectively, may be added as message content to an MMS message, email message, and sent to another mobile device. The video and/or photo content also can be shared with other devices via various types of data transfers via wired and/or wireless communication devices as described herein.

The mobile device 400 also can include one or more location components 436. The location components 436 can be configured to send and/or receive signals to determine a location of the mobile device 400. According to various embodiments, the location components 436 can send and/or receive signals from GPS devices, assisted-GPS (“A-GPS”) devices, WI-FI/WIMAX and/or cellular network triangulation data, combinations thereof, and the like. The location component 436 also can be configured to communicate with the communications component 418 to retrieve triangulation data for determining a location of the mobile device 400. In some embodiments, the location component 436 can interface with cellular network nodes, telephone lines, satellites, location transmitters and/or beacons, wireless network transmitters and receivers, combinations thereof, and the like. In some embodiments, the location component 436 can include and/or can communicate with one or more of the sensors 424 such as a compass, an accelerometer, and/or a gyroscope to determine the orientation of the mobile device 400. Using the location component 436, the mobile device 400 can generate and/or receive data to identify its geographic location, or to transmit data used by other devices to determine the location of the mobile device 400. The location component 436 may include multiple components for determining the location and/or orientation of the mobile device 400.

The illustrated mobile device 400 also can include a power source 438. The power source 438 can include one or more batteries, power supplies, power cells, and/or other power subsystems including alternating current (“AC”) and/or direct current (“DC”) power devices. The power source 438 also can interface with an external power system or charging equipment via a power I/O component 440. Because the mobile device 400 can include additional and/or alternative components, the above embodiment should be understood as being illustrative of one possible operating environment for various embodiments of the concepts and technologies described herein. The described embodiment of the mobile device 400 is illustrative, and should not be construed as being limiting in any way.

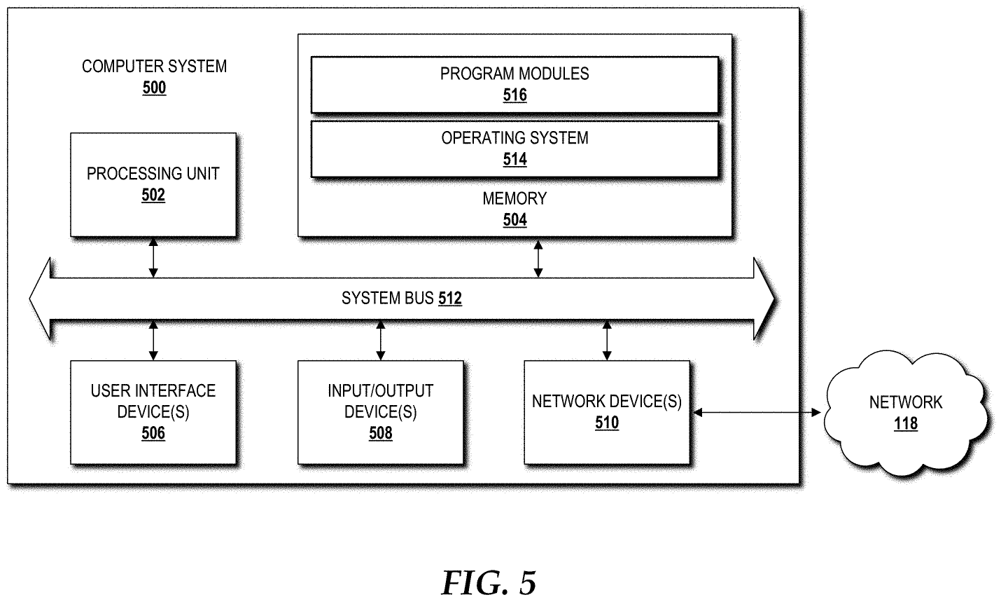

Turing now to FIG. 5, a block diagram illustrating a computer system 500 configured to provide the functionality described herein in accordance with various embodiments of the concepts and technologies disclosed herein. In some embodiments, the user device(s) 134, the IoT device(s) 132, the vehicle system(s) 106, and/or other devices/systems can be configured as and/or can have an architecture similar or identical to the computer system 500 described herein with respect to FIG. 5. It should be understood, however, that the user device(s) 134, the IoT device(s) 132, and/or the vehicle system(s) 106 may or may not include the functionality described herein with reference to FIG. 5.

The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the computer system 500.

The memory 504 communicates with the processing unit 502 via the system bus 512. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 516 may include various software and/or program modules described herein. By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer to output data.

The network devices 510 enable the computer system 500 to communicate with other networks or remote systems via one or more networks, such as the network 118. Examples of the network devices 510 include, but are not limited to, a modem, a radio frequency (“RF”) or infrared (“IR”) transceiver, a telephonic interface, a bridge, a router, or a network card. The network(s) may include a wireless network such as, but not limited to, a WLAN such as a WI-FI network, a WWAN, a Wireless Personal Area Network (“WPAN”) such as BLUETOOTH, a WMAN such a WiMAX network, or a cellular network. Alternatively, the network(s) may be a wired network such as, but not limited to, a WAN such as the Internet, a LAN, a wired PAN, or a wired MAN.

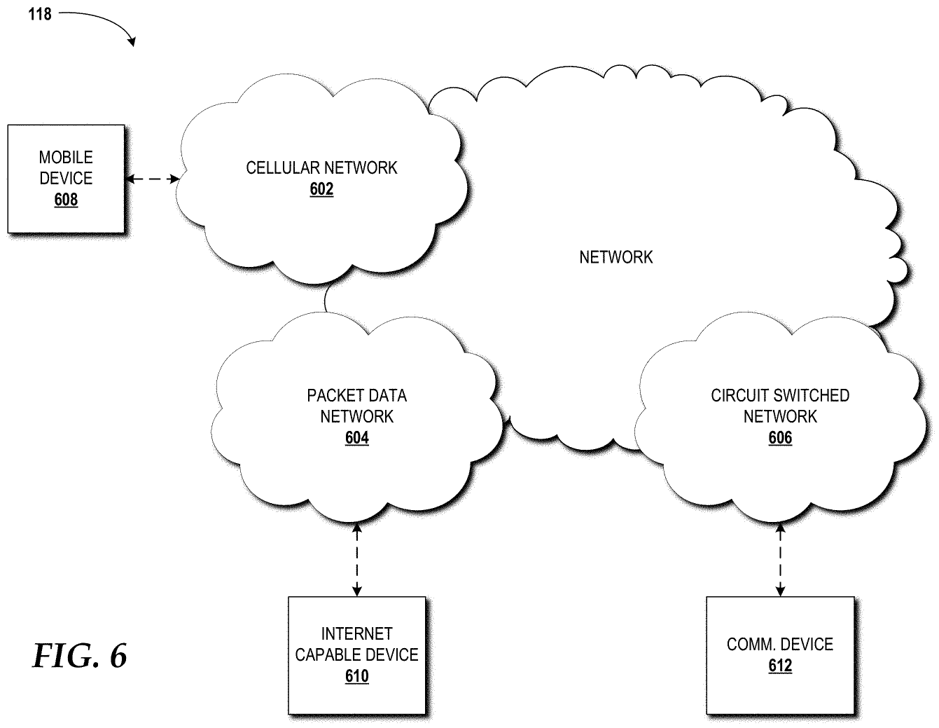

Turning now to FIG. 6, additional details of an embodiment of the network 118 are illustrated, according to an illustrative embodiment. The network 118 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 602 also includes radios and nodes for receiving and transmitting voice, data, and combinations thereof to and from radio transceivers, networks, the packet data network 604, and the circuit switched network 606.

A mobile communications device 608, such as, for example, the user devices 134, a cellular telephone, a user equipment, a mobile terminal, a PDA, a laptop computer, a handheld computer, and combinations thereof, can be operatively connected to the cellular network 602. The cellular network 602 can be configured as a 2G GSM network and can provide data communications via GPRS and/or EDGE. Additionally, or alternatively, the cellular network 602 can be configured as a 3G UMTS network and can provide data communications via the HSPA protocol family, for example, HSDPA, EUL (also referred to as HSDPA), and HSPA+. The cellular network 602 also is compatible with 4G mobile communications standards as well as evolved and future mobile standards.

The packet data network 604 includes various devices, for example, servers, computers, databases, and other devices in communication with another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (“POTS”). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 608, for example, the AR system 102, the vehicle system(s) 106, the user device(s) 134, the IoT device(s) 132, a personal computer (“PC”), a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 118 may be used to refer broadly to any combination of the networks 602, 604, 606. It should be appreciated that substantially all of the functionality described with reference to the network 118 can be performed by the cellular network 602, the packet data network 604, and/or the circuit switched network 606, alone or in combination with other networks, network elements, and the like.

Based on the foregoing, it should be appreciated that aspects of selective presentation of augmented reality objects have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
retrieving, by an augmented reality (“AR”) system, a live video image;
receiving, by the AR system, a first message for AR presentation;
determining, by the AR system, from the live video image, a first AR object anchor over which a first AR object that is representative of the first message is to be presented;
presenting, by the AR system, over the first AR object anchor, the first AR object that is representative of the first message;
receiving, by the AR system, a subsequent message for AR presentation, wherein the subsequent message is associated with and different from the first message;
determining, by the AR system, from the live video image, a second AR object anchor over which a second AR object that is representative of the subsequent message is to be presented; and
presenting, by the AR system, over the second AR object anchor, the second AR object that is representative of the subsequent message.

2. The method of claim 1, further comprising:
receiving, by the AR system, a notification; and
in response to the notification, determining, by the AR system, to forgo presentation, over the second AR object anchor, of the second AR object that is representative of the subsequent message, and instead presenting, over the second AR object anchor, a third AR object that is representative of the notification.

3. The method of claim 2, further comprising:
determining, by the AR system, from the live video image, a third AR object anchor over which the second AR object that is representative of the subsequent message is to be presented; and
presenting, by the AR system, over the third AR object anchor, the second AR object that is representative of the subsequent message.

4. The method of claim 3, wherein the live video image shows a roadway and a plurality of road signs, and wherein each of the first AR object anchor, the second AR object anchor, and the third AR object anchor is associated with at least one of the plurality of road signs.

5. The method of claim 4, wherein the first message and the subsequent message are text messages.

6. The method of claim 5, wherein the notification is associated with a priority ranking that prioritizes the notification over the subsequent message.

7. The method of claim 6, wherein the notification is associated with an application executed by a user device, an Internet of Things device, a vehicle system notification, a travel notification, a roadwork notification, an AMBER alert notification, a government notification, or a weather notification.

8. An augmented reality (“AR”) system comprising:
a communications component;
a camera component;
an AR display;
a processor; and
a memory having instructions stored thereon that, when executed by the processor, cause the processor to perform operations comprising
retrieving, from the camera component, a live video image,
receiving, via the communications component, a first message for AR presentation,
determining, from the live video image, a first AR object anchor over which a first AR object that is representative of the first message is to be presented,
presenting, via the AR display, over the first AR object anchor, the first AR object that is representative of the first message,
receiving, via the communications component, a subsequent message for AR presentation, wherein the subsequent message is associated with and different from the first message,
determining, from the live video image, a second AR object anchor over which a second AR object that is representative of the subsequent message is to be presented,
receiving, via the communications component, a notification, and
in response to the notification, determining to forgo presentation, over the second AR object anchor, of the second AR object that is representative of the subsequent message, and instead presenting, via the AR display, over the second AR object anchor, a third AR object that is representative of the notification.

9. The AR system of claim 8 wherein:
determining, from the live video image, a third AR object anchor over which the second AR object that is representative of the subsequent message is to be presented; and
presenting, via the AR display, over the third AR object anchor, the second AR object that is representative of the subsequent message.

10. The AR system of claim 9, wherein the live video image shows a roadway and a plurality of road signs.

11. The AR system of claim 10, wherein each of the first AR object anchor, the second AR object anchor, and the third AR object anchor is associated with at least one of the plurality of road signs.

12. The AR system of claim 11, wherein the first message and the subsequent message are text messages.

13. The AR system of claim 12, wherein the notification is associated with a priority ranking that prioritizes the notification over the subsequent message.

14. The AR system of claim 13, wherein the notification is associated with an application executed by a user device, an Internet of Things device, a vehicle system notification, a travel notification, a roadwork notification, an AMBER alert notification, a government notification, or a weather notification.

15. A computer-readable storage medium having computer-executable instructions stored thereon that, when executed by a processor, cause the processor to perform operations comprising:
retrieving a live video image;
receiving a first message for an augmented reality (“AR”) presentation;
determining, from the live video image, a first AR object anchor over which a first AR object that is representative of the first message is to be presented;
presenting, over the first AR object anchor, the first AR object that is representative of the first message;
receiving a subsequent message for AR presentation, wherein the subsequent message is associated with and different from the first message;
determining, from the live video image, a second AR object anchor over which a second AR object that is representative of the subsequent message is to be presented;
receiving a notification; and
in response to the notification, determining to forgo presentation, over the second AR object anchor, of the second AR object that is representative of the subsequent message, and instead presenting, over the second AR object anchor, a third AR object that is representative of the notification.

16. The computer-readable storage medium of claim 15, wherein the operations further comprise:
determining, from the live video image, a third AR object anchor over which the second AR object that is representative of the subsequent message is to be presented; and
presenting, over the third AR object anchor, the second AR object that is representative of the subsequent message.

17. The computer-readable storage medium of claim 16, wherein the live video image shows a roadway and a plurality of road signs.

18. The computer-readable storage medium of claim 17, wherein each of the first AR object anchor, the second AR object anchor, and the third AR object anchor is associated with at least one of the plurality of road signs.

19. The computer-readable storage medium of claim 18, wherein the first message and the subsequent message are text messages, and wherein the notification is associated with a priority ranking that prioritizes the notification over the subsequent message.

20. The computer-readable storage medium of claim 19, wherein the notification is associated with an application executed by a user device, an Internet of Things device, a vehicle system notification, a travel notification, a roadwork notification, an AMBER alert notification, a government notification, or a weather notification.
